(19) United States
(12) Patent Application Publication
(10) Pub. No.: US 2018/0062441 A1
(43) Pub. Date: Mar. 1, 2018

(54) Segmented and Longitudinal Receiver Coil Arrangements for Wireless Power Transfer

(71) Applicant: Sanjaya Maniktala, Fremont, CA (US)

(72) Inventor: Sanjaya Maniktala, Fremont, CA (US)

(21) Appl. No.: 15/693,201

(22) Filed: Aug. 31, 2017

Related U.S. Application Data
(60) Provisional application No. 62/382,260, filed on Sep. 1, 2016.

(51) Int. Cl. H02J 50/10; H02J 7/02; H02J 7/04; H01F 27/28; H01F 27/24

(52) U.S. Cl. CPC H02J 50/10; H02J 7/025; H01F 27/24; H01F 27/28; H02J 7/04

(57) ABSTRACT

In one embodiment, a receiver coil arrangement for wireless power transfer includes a segmented coil structure having a plurality of solenoid coil structures arranged such that a longitudinal axis of each of the plurality of solenoid coil structures is substantially parallel to a first spatial direction in a first plane, and the plurality of solenoid coil structures are not coaxial, the plurality of solenoid coil structures being electrically coupled together in series. In one embodiment, the receiver coil arrangement further includes a second solenoid coil structure arranged such that a longitudinal axis of the second solenoid coil structure lies in the first plane substantially perpendicular to the first spatial direction. In one embodiment, the second solenoid coil structure includes a helical coil wound around a magnetic core. In one embodiment, the second solenoid coil structure includes a split helical coil including two coil portions wound around a magnetic core, the two coil portions located symmetrically about a geometric center of the magnetic core, and the second solenoid coil structure further includes a third helical coil wound around the magnetic core.

### CROSS-REFERENCE TO RELATED APPLICATIONS

This application claims the benefit of U.S. Provisional Patent Application No. 62/382,260, entitled “Longitudinal Receiver Coil Arrangements for Wireless Power Transfer,” filed on Sep. 1, 2016. The subject matter of the related application is hereby incorporated by reference in its entirety.

### FIELD OF THE INVENTION

The invention relates generally to wireless power transfer and more particularly to segmented and longitudinal receiver coil arrangements for wireless power transfer.

### BACKGROUND

Electronic devices typically require a connected (wired) power source to operate, for example, battery power or a wired connection to a direct current (“DC”) or alternating current (“AC”) power source. Similarly, rechargeable battery-powered electronic devices are typically charged using a wired power-supply that connects the electronic device to a DC or AC power source. The limitation of these devices is the need to directly connect the device to a power source using wires.

Wireless power transfer (WPT) involves the use of time-varying magnetic fields to wirelessly transfer power from a source to a device. Faraday's law of magnetic induction provides that if a time-varying current is applied to one coil (e.g., a transmitter coil) a voltage will be induced in a nearby second coil (e.g., a receiver coil). The voltage induced in the receiver coil can then be rectified and filtered to generate a stable DC voltage for powering an electronic device or charging a battery. The receiver coil and associated circuitry for generating a DC voltage can be connected to or included within the electronic device itself such as a smartphone.

The Wireless Power Consortium (WPC) was established in 2008 to develop the Qi inductive power standard for charging and powering electronic devices. Powermat is another well-known standard for WPT developed by the Power Matters Alliance (PMA). The Qi and Powermat near-field standards operate in the frequency band of 100-400 kHz. The problem with near-field WPT technology is that typically only 5 Watts of power can be transferred over the short distance of 2 to 5 millimeters between a power source and an electronic device, though there are ongoing efforts to increase the power. For example, some concurrently developing standards achieve this by operating at much higher frequencies, such as 6.78 MHz or 13.56 MHz. Though they are called magnetic resonance methods instead of magnetic induction, they are based on the same underlying physics of magnetic induction. There also have been some market consolidation efforts to unite into larger organizations, such as the AirFuel Alliance consisting of PMA and the Rezence standard from the Alliance For Wireless Power (A4WP), but the technical aspects have remained largely unchanged.

Due to the short range of the above-described WPT technology, the receiver coil of a wirelessly-chargeable electronic device must be centered with the transmitter coil and the transmitter and receiver coils cannot be more than about 2-5 millimeters apart. This makes it difficult to implement wireless power transfer for devices that do not have at least one surface that is perfectly flat or do not have a large enough area for embedding a typical receiver coil (e.g., Android® wearable devices, Apple® watch, Fitbit® fitness tracker, etc.). The limitations of the above-described WPT technology also affect smartphones if the charging surface with the transmitter coil is not large enough to allow the smartphone device to sit flat on the surface (e.g., in vehicles, which typically do not have a flat surface large enough to accommodate a smartphone device). Further, the need for a receiver coil to be aligned with a transmitter coil requires a user to take more care in placing a wirelessly-chargeable device on a charging surface. Thus there is a need for a technique for wireless power transfer that improves the efficiency of power transfer to a wirelessly-chargeable device and is less sensitive to precise alignment of a receiver coil with a transmitter coil.

### SUMMARY

In one embodiment, a receiver coil arrangement for wireless power transfer includes a segmented coil structure having a plurality of solenoid coil structures arranged such that a longitudinal axis of each of the plurality of solenoid coil structures is substantially parallel to a first spatial direction in a first plane, and the plurality of solenoid coil structures are not coaxial, the plurality of solenoid coil structures being electrically coupled together in series. In one embodiment, the receiver coil arrangement further includes a second solenoid coil structure arranged such that a longitudinal axis of the second solenoid coil structure lies in the first plane substantially perpendicular to the first spatial direction. In one embodiment, the second solenoid coil structure includes a helical coil wound around a magnetic core. In one embodiment, the second solenoid coil structure includes a split helical coil including two coil portions wound around a magnetic core, the two coil portions located symmetrically about a geometric center of the magnetic core, and the second solenoid coil structure further includes a third helical coil wound around the magnetic core.

### BRIEF DESCRIPTION OF THE DRAWINGS

FIG. 1A is a diagram illustrating one embodiment of a receiver coil arrangement for wireless power transfer, according to the invention.

FIG. 1B is a diagram illustrating one embodiment of one of the plurality of receiver coil structures of FIG. 1A, according to the invention.

FIG. 2 is a diagram illustrating one embodiment of a receiver coil arrangement for wireless power transfer, according to the invention.

FIG. 3 is a diagram illustrating one embodiment of a receiver coil arrangement for wireless power transfer, according to the invention.

FIG. 4 is a diagram illustrating one embodiment of a receiver coil arrangement in a receiver for wireless power transfer, according to the invention.

FIG. 5 is a diagram illustrating one embodiment of an electronic device including a receiver coil arrangement for wireless power transfer, according to the invention.

FIG. 6 is a diagram illustrating one embodiment of a receiver coil arrangement in a receiver for wireless power transfer, according to the invention.

### DETAILED DESCRIPTION

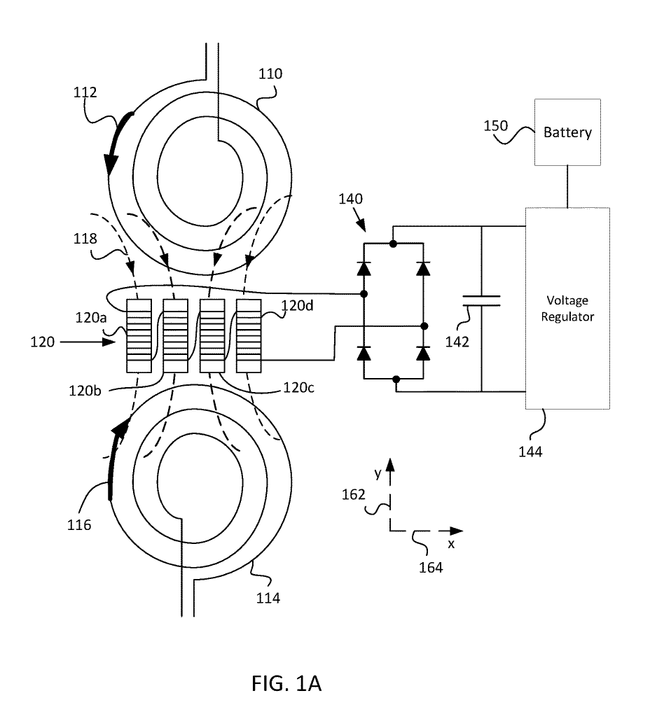

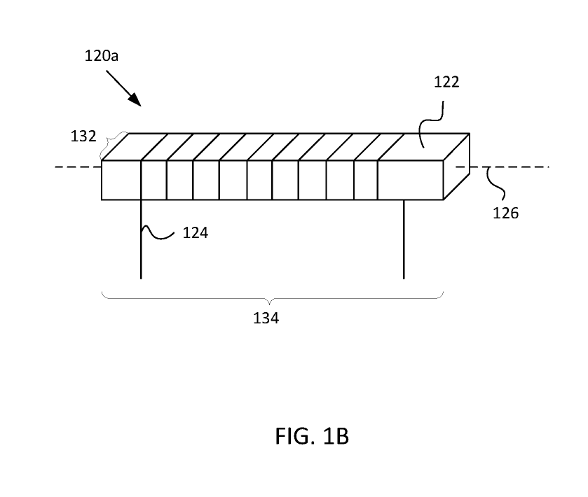

FIG. 1A is a diagram illustrating one embodiment of a receiver coil arrangement 120 for wireless power transfer, according to the invention. Receiver coil arrangement 120 includes a plurality of receiver coil structures 120a-120d. Receiver coil structures 120a-120d are arranged side-by-side; that is, longitudinal axes of receiver coil structures 120a-120d lie substantially parallel to one another and a y-axis 162, and receiver coil structures 120a-120d do not share a common longitudinal axis (i.e., receiver coil structures 120a-120d are not coaxial). Receiver coil structures 120a-120d are electrically coupled together in series such that voltages induced in receiver coil structures 120a-120d add together, producing a net induced voltage in receiver coil arrangement 120. In other words, if V is the induced voltage across each of receiver coil structures 120a-120d, and n is the number of receiver coil structures 120a-120d in receiver coil arrangement 120, the net induced voltage in receiver coil arrangement is n x V. Although receiver coil arrangement 120 in the FIG. 1A embodiment includes four receiver coil structures 120a-120d, any number of receiver coil structures greater than one is within the scope of the invention. Each of receiver coil structures 120a-120d includes a helical coil wound around a magnetic core. In one embodiment, each helical coil of receiver coil structures 120a-120d has the same number of windings and the same winding polarity as every other helical coil of receiver coil structures 120a-120d.

FIG. 1A shows receiver coil structure 120 in a position above a wireless power transmitter coil 110 and a wireless power transmitter coil 114. Transmitter coil 110 and transmitter coil 114 are arranged over a magnetic layer (not shown), which in one embodiment is made of ferrite, that magnetically couples transmitter coils 110 and 114 together. Transmitter coil 110 and transmitter coil 114 are coupled to a power circuit (not shown) that provides a time-varying current to transmitter coil 110 and transmitter coil 114. Transmitter coil 110 and transmitter coil 114 are configured such that when a time-varying current 112 flows in a counter-clockwise direction in transmitter coil 110 a time-varying current 116 flows in a clockwise direction in transmitter coil 114. The opposite polarities of time-varying currents 112 and 116 flowing in transmitter coils 110 and 114 produce magnetic fields, represented by closed flux lines 118, having opposite polarities that couple together between transmitter coil 110 and transmitter coil 114. Flux lines 118 of the magnetic field are substantially horizontal in relation to a plane formed by transmitter coil 110 and transmitter coil 114. One embodiment of a transmitter having two coils configured to produce magnetic fields of opposite polarities is described in U.S. patent application Ser. No. 15/082,533, entitled “Wireless Power Transfer Using Multiple Coil Arrays,” the subject matter of which is hereby incorporated by reference in its entirety.

Flux lines 118 of the magnetic field induce a time-varying current in receiver coil structure 120. When an induced current is flowing in receiver coil structure 120 the current is input to a rectifier bridge 140, which rectifies the signal and outputs the rectified signal across a capacitor 142. As shown in FIG. 1A, in one embodiment rectifier bridge 140 is implemented as a four-diode bridge. A voltage regulator 144 defines an output voltage magnitude and maintains the voltage under load. The voltage generated by voltage regulator 144 can be used to charge a battery 150 or directly power a device (not shown), e.g., a smart phone, laptop, drone, or any other electronic device.

FIG. 1B is a diagram illustrating one embodiment of one of the plurality of receiver coil structures 120a of FIG. 1A, according to the invention. Receiver coil structure 120a includes a magnetic core 122 and a helical coil 124. Magnetic core 122 has the shape of a parallelepiped having a width 132 and a length 134; however any other shape such as a circular or elliptical cylinder or a thin sheet is within the scope of the invention. Magnetic core 122 is made of a magnetic material such as ferrite. Helical coil 124 is wrapped around magnetic core 122 such that helical coil 124 and magnetic core 122 share a longitudinal axis 126; the combination of helical coil 124 and magnetic core 122 may be referred to as a solenoid coil structure. Helical coil 124 is preferably formed of wire made from a conductive material such as copper, gold, or any other conductive material known in the art. In one embodiment, each of receiver coil structures 120b, 120c, and 120d of FIG. 1A is implemented as receiver coil structure 120a.

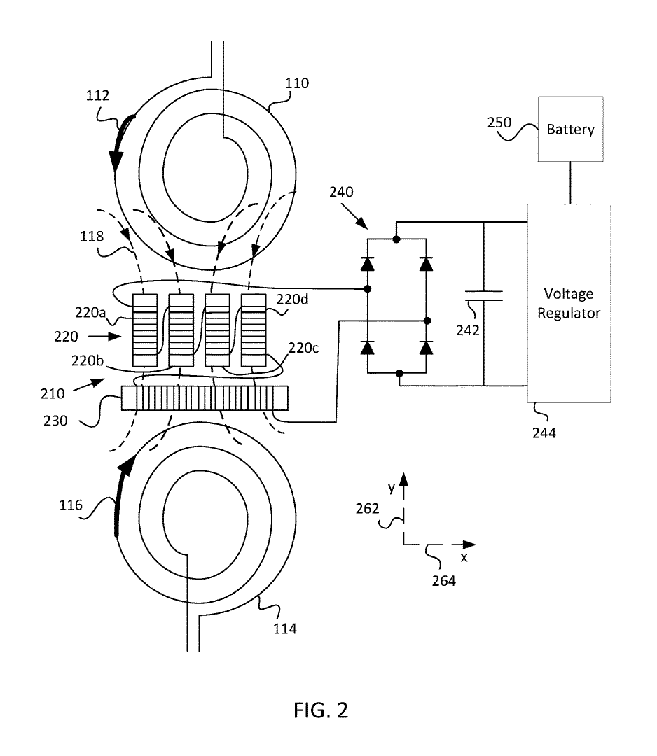

FIG. 2 is a diagram illustrating one embodiment of a receiver coil arrangement 210 for wireless power transfer, according to the invention. Receiver coil arrangement 210 includes a segmented coil arrangement 220 and a longitudinal coil structure 230. Segmented coil arrangement 220 includes a plurality of receiver coil structures 220a-220d. Receiver coil structures 220a-220d are arranged side-by-side; that is, longitudinal axes of receiver coil structures 220a, 220b, 220c, and 220d lie substantially parallel to one another and a y-axis 262 within a plane defined by y-axis 262 and an x-axis 264, and receiver coil structures 220a-220d do not share a common longitudinal axis (i.e., receiver coil structures 220a-220d are not coaxial). Receiver coil structures 220a-220d are electrically coupled together in series such that voltages induced in receiver coil structures 220a-220d add together, producing a net induced voltage in segmented coil arrangement 220. Each of receiver coil structures 220a-220d includes a helical coil wound around a magnetic core, which in one embodiment is made of ferrite. In one embodiment, each helical coil of receiver coil structures 220a-220d has the same number of windings and the same winding polarity as every other helical coil of receiver coil structures 220-220d. Although segmented coil arrangement 220 in the FIG. 2 embodiment includes four receiver coil structures 220a-220d, any number of receiver coil structures greater than one is within the scope of the invention.

Segmented coil arrangement 220 is electrically coupled in series with longitudinal coil structure 230. Longitudinal coil structure 230 is arranged within receiver coil arrangement 210 such that a longitudinal axis of longitudinal coil structure 230 is substantially perpendicular to the longitudinal axes of receiver coil structures 220a-220d, i.e., substantially parallel to x-axis 264, in substantially the same plane. Longitudinal coil structure 230 includes a helical coil wound around a magnetic core, which in one embodiment is made of ferrite.

FIG. 2 shows receiver coil structure 210 in a position above wireless power transmitter coil 110 and wireless power transmitter coil 114. Transmitter coil 110 and transmitter coil 114 are arranged over a magnetic layer (not shown), which in one embodiment is made of ferrite, that magnetically couples transmitter coils 110 and 114 together. Transmitter coil 110 and transmitter coil 114 are coupled to a power circuit (not shown) that provides a time-varying current to transmitter coil 110 and transmitter coil 114. Transmitter coil 110 and transmitter coil 114 are configured such that when a time-varying current 112 flows in a counter-clockwise direction in transmitter coil 110 a time-varying current 116 flows in a clockwise direction in transmitter coil 114. The opposite polarities of time-varying currents 112 and 116 flowing in transmitter coils 110 and 114 produce a magnetic field represented by closed flux lines 118. Flux lines 118 of the magnetic field are substantially horizontal in relation to a plane formed by transmitter coil 110 and transmitter coil 114.

Flux lines 118 of the magnetic field induce a time-varying current in segmented coil arrangement 220 of receiver coil structure 210. Longitudinal coil structure 230 is arranged such that its longitudinal axis is substantially perpendicular to the longitudinal axes of receiver coil structures 220a-220d, so when receiver coil structure 210 is oriented with respect to transmitter coils 110 and 114 as shown in FIG. 2 flux lines 118 of the magnetic field induce a very small or no current in longitudinal coil structure 230; however, the time-varying current induced in segmented coil arrangement 220 flows in longitudinal coil structure 230 because segmented coil arrangement 220 is electrically coupled in series with longitudinal coil structure 230. When an induced current is flowing in receiver coil structure 210 the current is input to a rectifier bridge 240, which rectifies the signal and outputs the rectified signal across a capacitor 242. A voltage regulator 244 defines an output voltage magnitude and maintains the voltage under load. The voltage generated by voltage regulator 144 can be used to charge a battery 250 or directly power a device (not shown), e.g., a smart phone, laptop, drone, or any other electronic device.

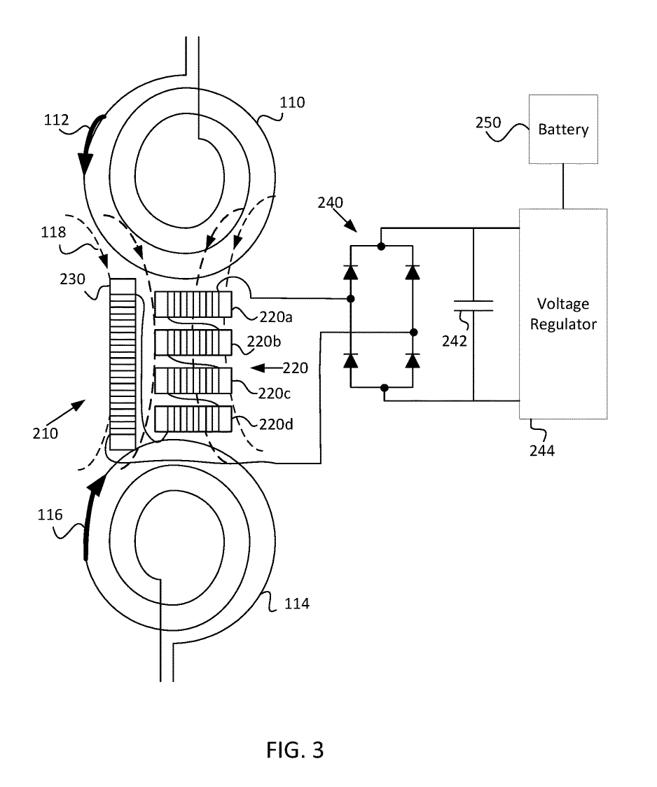

FIG. 3 is a diagram illustrating one embodiment of a receiver coil arrangement 210 for wireless power transfer, according to the invention. As shown in FIG. 3, receiver coil arrangement 210 is positioned with respect to transmitter coil 110 and transmitter coil 114 such that flux lines 118 of the magnetic field induce a time-varying current in longitudinal coil structure 230. Segmented coil arrangement 220 is arranged such that the longitudinal axes of receiver coil structures 220a-220d are substantially perpendicular to the longitudinal axis of longitudinal coil structure 230, so when receiver coil structure 210 is oriented with respect to transmitter coils 110 and 114 as shown in FIG. 3 flux lines 118 of the magnetic field induce a very small or no current in segmented coil arrangement 220; however, the time-varying current induced in longitudinal coil structure 230 flows in segmented coil arrangement 220 because longitudinal coil structure 230 is electrically coupled in series with segmented coil arrangement 220.

FIG. 3 shows receiver coil arrangement 210 in an orientation with respect to transmitter coils 110 and 114 that is ninety degrees from its orientation with respect to transmitter coils 110 and 114 shown in FIG. 2. As shown in FIGS. 2 and 3, receiver coil arrangement 210 will receive wireless power from the transmitter in more than one orientation with respect to flux lines 118 of the magnetic field. Assuming the orientation of receiver coil structure 210 shown in FIG. 2 is defined as zero degrees, if receiver coil structure 210 is rotated from zero degrees to ninety degrees, segmented coil arrangement 220 will receive a decreasing amount of the energy from the magnetic field and longitudinal coil structure 230 will receive an increasing amount of the energy from the magnetic field until the majority of the energy from the magnetic field is received by longitudinal coil structure (as shown in FIG. 3). Receiver coil structure 210 thus does not require a particular alignment with respect to transmitter coils 110 and 114 to receive wireless power.

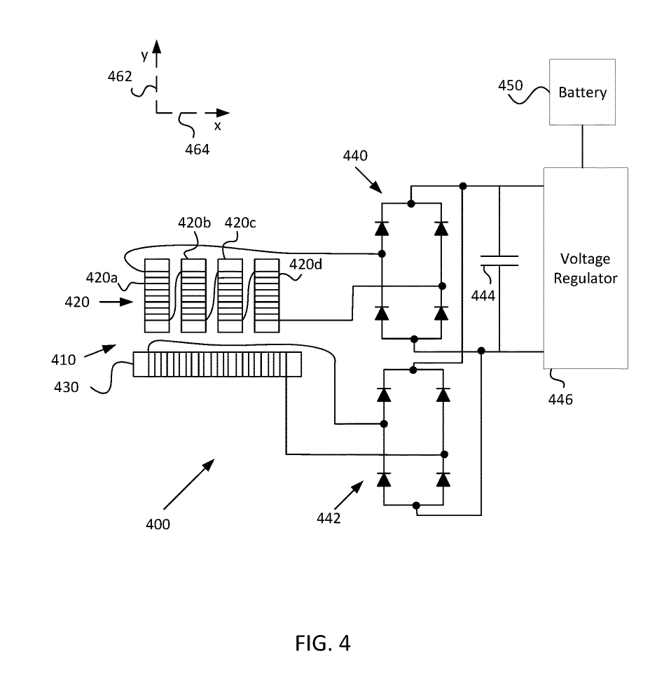

FIG. 4 is a diagram illustrating one embodiment of a receiver coil arrangement 410 in a receiver 400 for wireless power transfer, according to the invention. Receiver coil arrangement 410 includes a segmented coil arrangement 420 and a longitudinal coil structure 430. Segmented coil arrangement 420 includes a plurality of receiver coil structures 420a-420d. Receiver coil structures 420a-420d are arranged side-by-side; that is, longitudinal axes of receiver coil structures 420a-420d lie substantially parallel to one another and a y-axis 462 within a plane defined by y-axis 462 and an x-axis 464, and receiver coil structures 420a-420d do not share a common longitudinal axis (i.e., receiver coil structures 420a-420d are not coaxial). Receiver coil structures 420a-420d are electrically coupled together in series such that voltages induced in receiver coil structures 420a-420d add together, producing a net induced voltage in segmented coil arrangement 420. Each of receiver coil structures 420a-420d includes a helical coil wound around a magnetic core, which in one embodiment is made of ferrite. In one embodiment, each helical coil of receiver coil structures 420a-420d has the same number of windings and the same winding polarity as every other helical coil of receiver coil structures 420a-420d. Although segmented coil arrangement 420 in the FIG. 4 embodiment includes four receiver coil structures 420a-420d, any number of receiver coil structures greater than one is within the scope of the invention. Longitudinal coil structure 430 is arranged within receiver coil arrangement 410 such that a longitudinal axis of longitudinal coil structure 430 is substantially perpendicular to the longitudinal axes of receiver coil structures 420a-420d, i.e., substantially parallel to x-axis 464, in substantially the same plane. Longitudinal coil structure 430 includes a helical coil wound around a magnetic core, which in one embodiment is made of ferrite.

Segmented coil arrangement 420 is coupled to a rectifier bridge 440 and longitudinal coil structure 430 is coupled to a rectifier bridge 442. When an induced current is flowing in segmented coil arrangement 420 the current is input to rectifier bridge 440, which rectifies the signal and outputs the rectified signal across a capacitor 444. When an induced current is flowing in longitudinal coil structure 430 the current is input to rectifier bridge 442, which rectifies the signal and outputs the rectified signal across capacitor 444. A voltage regulator 446 defines an output voltage magnitude and maintains the voltage under load. The voltage generated by voltage regulator 446 can be used to charge a battery 450 or directly power a device (not shown), e.g., a smart phone, laptop, drone, or any other electronic device. In receiver 400, rectifier bridge 440 and rectifier bridge 442 act similarly to a logic OR in that only one of segmented coil arrangement 420 or longitudinal coil structure 430 that develops a net voltage from energy received from a magnetic field will provide a substantial voltage across capacitor 444.

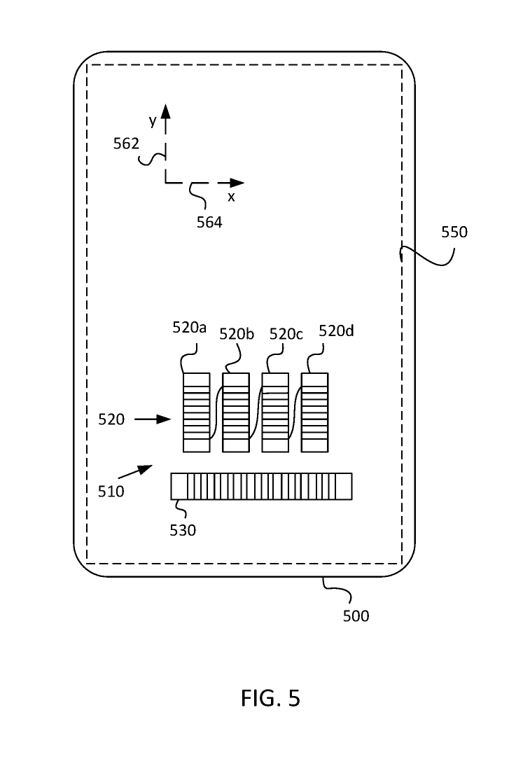

FIG. 5 is a diagram illustrating one embodiment of an electronic device 500 including a receiver coil arrangement 510 for wireless power transfer, according to the invention. Receiver coil arrangement 510 includes a segmented coil arrangement 520 and a longitudinal coil structure 530 that are located beneath an outer surface 550 of electronic device 500. Outer surface 550 is preferably made of non-magnetic material such as plastic or glass. Receiver coil arrangement 510 is electrically coupled to a rectifier circuit, capacitor, and voltage regulator (not shown) that produce a voltage to charge a battery (not shown) of electronic device 500. Electronic device 500 can be a smartphone, a tablet, a laptop, an electric vehicle, or any other portable electronic device including a rechargeable battery.

Segmented coil arrangement 520 includes a plurality of receiver coil structures 520a-520d. Although segmented coil arrangement 520 in the FIG. 5 embodiment includes four receiver coil structures 520a-520d, any number of receiver coil structures greater than one is within the scope of the invention. The longitudinal axes of receiver coil structures 520a-520d of segmented coil arrangement 520 are substantially parallel to a y-axis 562 of electronic device 500 and the longitudinal axis of longitudinal coil structure 530 is substantially parallel to an x-axis 564 of electronic device 500. Similar to receiver coil arrangement 210 of FIGS. 2 and 3, receiver coil arrangement 510 does not require precise alignment with a transmitter including opposite polarity coils such as transmitter coil 110 and transmitter coil 114 to receive energy from the transmitter. If electronic device 500 is near a magnetic field having flux lines that are substantially parallel to the x-axis 564 of electronic device 500, longitudinal coil structure 530 will receive energy from the magnetic field and segmented coil structure 520 will receive little to no energy. If electronic device 500 is rotated in the plane defined by x-axis 564 and y-axis 562 such that flux lines from the magnetic field are substantially parallel to y-axis 562, segmented coil arrangement 520 will receive energy from the magnetic field and longitudinal coil structure 530 will receive little to no energy.

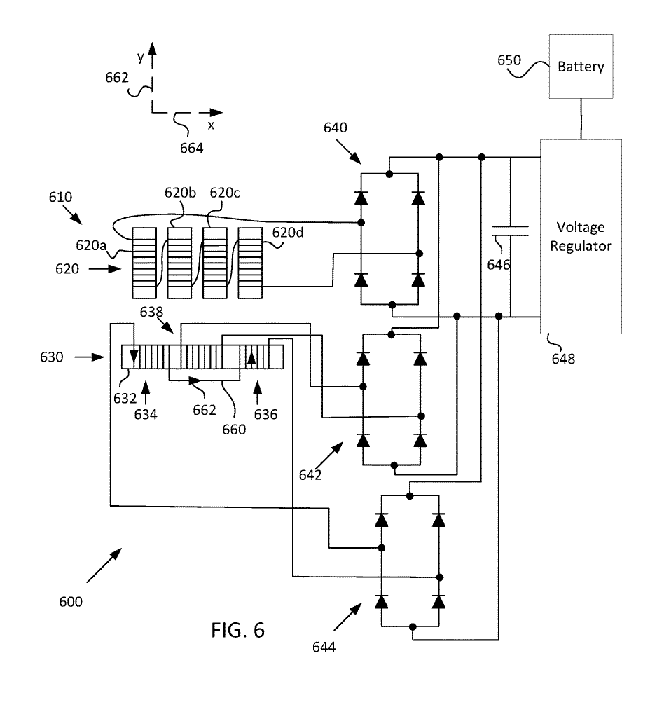

FIG. 6 is a diagram illustrating one embodiment of a receiver coil arrangement 610 in a receiver 600 for wireless power transfer, according to the invention. Receiver coil arrangement 610 includes a segmented coil arrangement 620 and a split coil structure 630. Segmented coil arrangement 620 includes a plurality of receiver coil structures 620a-620d. Receiver coil structures 620a-620d are arranged side-by-side; that is, longitudinal axes of receiver coil structures 620a-620d lie substantially parallel to one another and a y-axis 662 within a plane defined by y-axis 662 and an x-axis 664, and receiver coil structures 620a-620d do not share a common longitudinal axis (i.e., receiver coil structures 620a-620d are not coaxial). Receiver coil structures 620a-620d are electrically coupled together in series such that voltages induced in receiver coil structures 620a-620d add together, producing a net induced voltage in segmented coil arrangement 620. Each of receiver coil structures 620a-620d includes a helical coil wound around a magnetic core, which in one embodiment is made of ferrite. In one embodiment, each helical coil of receiver coil structures 620a-620d has the same number of windings and the same winding polarity as every other helical coil of receiver coil structures 620a-620d. Although segmented coil arrangement 620 in the FIG. 6 embodiment includes four receiver coil structures 620a-620d, any number of receiver coil structures greater than one is within the scope of the invention. Split coil structure 630 is arranged within receiver coil arrangement 610 such that a longitudinal axis of split coil structure 630 is substantially perpendicular to the longitudinal axes of receiver coil structures 620a-620d, i.e., substantially parallel to x-axis 664, in substantially the same plane.

Split coil structure 630 includes a magnetic core 632, which in one embodiment is made of ferrite, a split helical coil 660, and a third helical coil 638. Split helical coil 660 includes a first coil portion 634 and a second coil portion 636. First coil portion 634 and second coil portion 636 have the same number of windings and are located symmetrically on either side of a geometric center of magnetic core 632. Split helical coil 660 is wound around magnetic core 632 in such a way that when an induced current 662 flows in first coil portion 634 in a clockwise spatial direction (when viewed along a longitudinal axis of split coil structure 630) the induced current 662 flows in second coil portion 636 in a counter-clockwise spatial direction. Split helical coil 660 is configured to receive energy from a wireless power transmitter having a single transmitter coil, for example a wireless power transmitter that satisfies the Qi standard. Coil structures such as split coil structure 630 are disclosed in U.S. patent application Ser. No. 15/613,538, entitled “Coil Structures for Alignment and Inductive Wireless Power Transfer,” the subject matter of which is hereby incorporated by reference in its entirety. Thus receiver 600 can receive wireless power from more than one type of wireless power transmitter.

Segmented coil arrangement 620 is coupled to a rectifier bridge 640 and third helical coil 638 of split coil structure 630 is coupled to a rectifier bridge 642. First helical coil 634 is coupled in series with second helical coil 636 of split coil structure 630, and the combination of first helical coil 634 and second helical coil 636 is coupled to a rectifier bridge 644. When an induced current is flowing in segmented coil arrangement 620 the current is input to rectifier bridge 640, which rectifies the signal and outputs the rectified signal across a capacitor 646. When an induced current is flowing in third helical coil 638 of split coil structure 630 the current is input to rectifier bridge 642, which rectifies the signal and outputs the rectified signal across capacitor 646. When an induced current is flowing in split coil 660 the current is input to rectifier bridge 644, which rectifies the signal and outputs the rectified signal across capacitor 646. A voltage regulator 446 defines an output voltage magnitude and maintains the voltage under load. The voltage generated by voltage regulator 648 can be used to charge a battery 650 or directly power a device (not shown), e.g., a smart phone, laptop, drone, or any other electronic device.

In receiver 600, rectifier bridges 640, 642, and 644 act similarly to a logic OR in that only one of segmented coil arrangement 620, split helical coil 660, and third helical coil 638 that develops a net voltage from energy received from a magnetic field will provide a substantial voltage across capacitor 646. In another embodiment, segmented coil structure 620 is electrically coupled in series with third helical coil 638 of split coil structure 630, and the combination of segmented coil structure 620 and third helical coil 638 is electrically coupled to a rectifier circuit. Receiver coil arrangement 610 does not require precise alignment with a transmitter including opposite polarity coils such as transmitter coil 110 and transmitter coil 114 to receive energy from the transmitter, and is also able to receive energy from a single coil transmitter such as a Qi transmitter.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. An apparatus comprising:
a receiver coil arrangement comprising
a plurality of solenoid coil structures arranged such that a longitudinal axis of each of the plurality of solenoid coil structures is substantially parallel to a first spatial direction in a spatial plane, and the plurality of solenoid coil structures are not coaxial ;
the plurality of solenoid coil structures being electrically coupled together in series.

2. The apparatus of claim 1, wherein each of the plurality of solenoid coil structures comprises a core of magnetic material and a helical coil wrapped around the core.

3. The apparatus of claim 1, further comprising a rectifier circuit coupled to the receiver coil arrangement.

4. The apparatus of claim 3, further comprising a voltage regulator configured to receive a signal from the rectifier circuit and to produce an output voltage for charging a battery.

5. The apparatus of claim 1, wherein the receiver coil arrangement further comprises a second solenoid coil structure arranged such that a longitudinal axis of the second solenoid coil structure lies substantially in the spatial plane substantially perpendicular to the first spatial direction.

6. The apparatus of claim 5, wherein the plurality of solenoid coil structures is electrically coupled in series with the second solenoid coil structure.

7. The apparatus of claim 6, wherein the receiver coil arrangement is coupled to a rectifier circuit.

8. The apparatus of claim 5, wherein the plurality of solenoid coil structures is electrically coupled to a first rectifier circuit and the second solenoid coil structure is electrically coupled to a second rectifier circuit.

9. The apparatus of claim 5, wherein the second solenoid coil structure comprises a core of magnetic material and a helical coil wrapped around the core.

10. The apparatus of claim 5, wherein the second solenoid coil structure includes a split helical coil wound around a core of magnetic material and a third helical coil wound around the core, the split helical coil including a first coil portion and a second coil portion wound in such a way that when a current flows in a clockwise spatial direction in the first coil portion the current flows in a counter-clockwise spatial direction in the second coil portion.

11. The apparatus of claim 10, wherein the plurality of solenoid coil structures is electrically coupled to a first rectifier circuit, the split helical coil is electrically coupled to a second rectifier circuit, and the third helical coil is electrically coupled to a third rectifier circuit.

12. The apparatus of claim 10, wherein the first coil portion and the second coil portion of the spit helical coil are located symmetrically about a geometric center of the core.

13. The apparatus of claim 10, wherein the third helical coil is electrically coupled in series with the plurality of solenoid coil structures.

14. The apparatus of claim 5, further comprising a voltage regulator configured to receive a signal from at least one rectifier circuit electrically coupled to the receiver coil arrangement and to produce an output voltage for charging a battery.

15. An apparatus comprising:
a receiver coil arrangement comprising
a segmented coil structure comprising a plurality of solenoid coil structures arranged such that a longitudinal axis of each of the plurality of solenoid coil structures is substantially parallel to a first spatial direction in a first plane, and the plurality of solenoid coil structures are not coaxial,
each of the plurality of solenoid coil structures configured to produce a voltage in response to a magnetic field,
the plurality of solenoid coil structures being electrically coupled together in series such that voltages produced by the plurality of solenoid coil structures add together to produce a net voltage of the receiver coil arrangement.

16. The apparatus of claim 15, wherein the receiver coil arrangement further comprises a second solenoid coil structure arranged such that a longitudinal axis of the second solenoid coil structure lies substantially in the spatial plane substantially perpendicular to the first spatial direction.

17. The apparatus of claim 16, wherein the plurality of solenoid coil structures is electrically coupled in series with the second solenoid coil structure.

18. The apparatus of claim 16, wherein the plurality of solenoid coil structures is electrically coupled to a first rectifier circuit and the second solenoid coil structure is electrically coupled to a second rectifier circuit.

19. The apparatus of claim 16, wherein the second solenoid coil structure includes a split helical coil wound around a core of magnetic material and a third helical coil wound around the core, the split helical coil including a first coil portion and a second coil portion wound in such a way that when a current flows in a clockwise spatial direction in the first coil portion the current flows in a counter-clockwise spatial direction in the second coil portion.

20. The apparatus of claim 15, further comprising a voltage regulator configured to receive a signal from at least one rectifier circuit electrically coupled to the receiver coil arrangement and to produce an output voltage for charging a battery.
